(19) United States
(12) Patent Application Publication
(10) Pub. No.: US 2016/0042340 A1
(43) Pub. Date: Feb. 11, 2016

(54) CLOSED PREPAYMENT PROGRAM VIA MERCHANT POS TERMINALS

(71) Applicant: Roundmeup, Inc., Sarasota, FL (US)

(72) Inventors: Bertram V. Burke, Sarasota, FL (US); Michaela C. Burke, Sarasota, FL (US)

(21) Appl. No.: 14/822,842

(22) Filed: Aug. 10, 2015

Related U.S. Application Data
(60) Provisional application No. 62/035,139, filed on Aug. 8, 2014.

(51) Int. Cl. G06Q 20/28; G06Q 20/38; G06Q 20/20

(52) U.S. Cl. CPC G06Q 20/28; G06Q 20/202; G06Q 20/382

(57) ABSTRACT

A system for accumulating funds is provided. The system includes a database for storing a plurality of consumer profiles, a server for receiving from a point of sale (POS) terminal a unique identifier, accessing a consumer profile that corresponds to the unique identifier, transmitting to the POS terminal a prepayment determinant, receiving from the POS terminal the prepayment amount, and incrementing the current monetary value in the consumer profile based on the prepayment amount, and a POS terminal for transmitting to the server the consumer unique identifier, receiving from the server a prepayment determinant, reading a spending amount, calculating a prepayment amount based on the prepayment determinant and the spending amount, and transmitting to the server a message including the prepayment amount.

### CROSS-REFERENCE TO RELATED APPLICATIONS

This utility patent application claims priority to provisional application No. 62/035,139 entitled “Closed Program for Buying Merchandise at Sponsoring Merchants,” filed Aug. 8, 2014. The subject matter of provisional application No. 62/035,139 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to electronic commerce and, more specifically, to processes for merchant prepaid programs via point of sale (POS) terminals.

### BACKGROUND

Methods and programs for creating excess funds for saving or charitable giving have been disclosed. For example, U.S. Pat. Nos. 5,621,640 and 6,088,682 disclose methods and systems that require a customer to tender excess funds over and above the purchase price of merchandise or services. Excess funds are then assigned to a customer account managed by a central clearing house. The funds are transferred to the central clearing house, which then transfers the funds to the providers, selected by the customer. The system only operates when users tender excess cash, over and above the sale price. The POS terminal sends the data and cash to a central clearinghouse, which in turn forwards the cash to a variety of providers, selected by users.

In another example, merchants ask shoppers if they want have their coin change sent to a merchant-selected charity. This method does not create a personal account for the shopper and the merchant transfers the cash directly to the charity of choice. In another example, U.S. Pat. Nos. 6,112,191 and 8,025,217 disclose a rounding system whereupon banks offer their customers a service that rounds up checks and credit card transactions to the next $1, $2, $5, or any amount, or adds a specific dollar amount, such as $1.00, $1.50, $2.00, or any amount. The rounded amount would then be sent to a savings account at the bank that manages the checking account. The system requires that participating consumers have an operating checking account or a credit card account and a provider account.

Additional methods and programs for automatically accumulating funds or credits in a savings or charitable account have also been disclosed. In one example, U.S. Pat. Nos. 7,502,758 and 7,571,849, disclose methods and systems that allow a consumer to pre-define how he or she desires to save or donate using a particular account and thereafter any consumer spending transaction, such as using a debit card at a point of sale terminal, writing a check, or using a credit card, the consumer performs using the aforementioned account is subject to the predefined savings or donations scheme. This technique eliminates the need for the consumer to enter savings data at each spending transaction. The method, however, applies the predefined savings or donations scheme to all spending transactions the consumer performs using the particular account, which may not be desirable. Further, the method requires that the entity providing the savings or donations accounts also has access to the spending transaction data. If the savings or donations accounts provider is different and separate from the entity that possesses the spending transaction data, the account provider must request the spending transaction data. This may be problematic if the holder of the spending transaction data will not provide the data, presents obstacles to gaining access to the data or charges a fee for the data.

Lastly, U.S. Pat. No. 7,587,334 discloses a method and system for merchants to create an upsell by having the customers leave their coin change at the POS terminal. The method operates when a customer pays in cash and when the merchant offers an upsell.

Therefore, a need exists for improvements over the prior art, and more particularly for methods and systems that provide more flexibility when accumulating funds or credits on point of sale terminals.

### SUMMARY

A method and system that allows for customers to prepay merchants for merchandise or services that will later be selected by the customer. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for prepaying for merchandise or services is provided that solves the above-described problems. The system includes a database for storing a plurality of consumer profiles, wherein each profile includes a consumer unique identifier, a prepayment determinant, and a consumer account including a current monetary value; a server communicably coupled with the database and with a communications network, the server configured for: receiving from a point of sale (POS) terminal, via the communications network, a message including a consumer unique identifier; accessing, in the database, a consumer profile that corresponds to the consumer unique identifier; transmitting to the POS terminal, via the communications network, a message including a prepayment determinant from the consumer profile that corresponds to the consumer unique identifier; receiving from the POS terminal, via the communications network, the message including the prepayment amount; and incrementing the current monetary value in the consumer profile based on the prepayment amount; and a POS terminal communicably coupled with the communications network, the POS terminal configured for: reading input from a consumer, wherein the input includes a consumer unique identifier; transmitting to the server, via the communications network, a message including the consumer unique identifier; receiving from the server, via the communications network, a message including a prepayment determinant from the consumer profile that corresponds to the consumer unique identifier; reading a spending amount; calculating a prepayment amount based on the prepayment determinant and the spending amount; and transmitting to the server, via the communications network, a message including the prepayment amount. In addition to retail counters, POS terminals can be gas pumps, vending machines, toll booths, etc.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports the automatic accumulation of prepayment funds in a target account, according to an example embodiment;

FIG. 2A is a diagram showing the data flow of a setup process, according to an example embodiment;

FIG. 2B is a diagram showing the data flow of a prepayment accumulation process, according to an example embodiment;

FIG. 3 is a flow chart of a method for providing automatic accumulation of prepayment funds in a target account, according to an example embodiment;

FIG. 4 is a flow chart of a method for setting up the process of providing automatic accumulation of prepayment funds in a target account, according to an example embodiment;

FIG. 5 is a flow chart of a method for calculating prepayment amounts, according to an example embodiment; and

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The disclosed systems and methods improve over the prior bank rounding art by automatically loading onto a POS terminal the amount the consumer desires to prepay at each consumer spending transaction, thereby saving time for the consumer. Further, the disclosed systems and methods improve over the prior bank rounding art by applying a predefined prepayment scheme to certain spending transactions input by a user. The disclosed systems and methods improve over the prior bank rounding art by calculating the prepayment amount the consumer desires at the POS terminal at the time of purchase, rather than at a remote location. The disclosed systems and methods also improve over the bank rounding prior art by allowing the consumer to choose their prepayment determinant and to change their prepayment determinant at the POS, merchant's website, app, etc. Lastly, the disclosed systems and methods provide an opportunity for consumers without credit to establish a history of prepayment, which supports future credit worthiness.

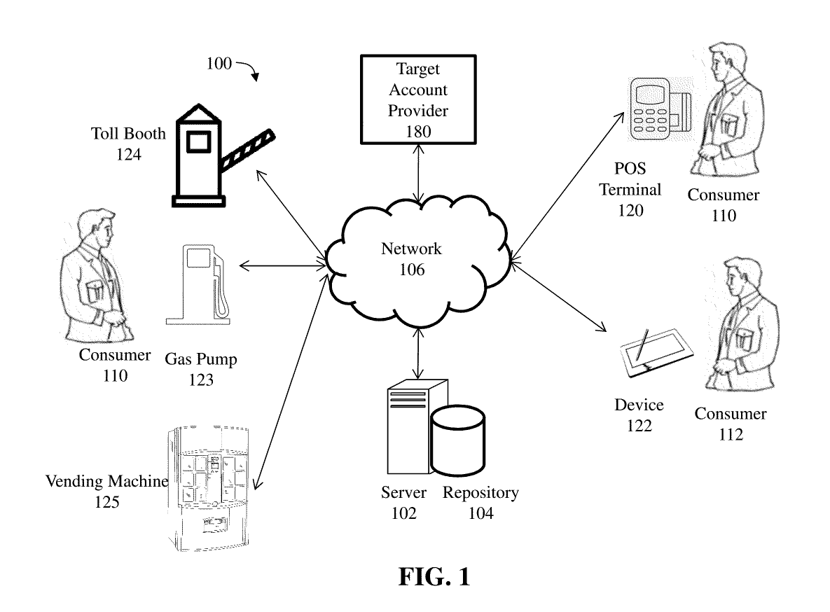

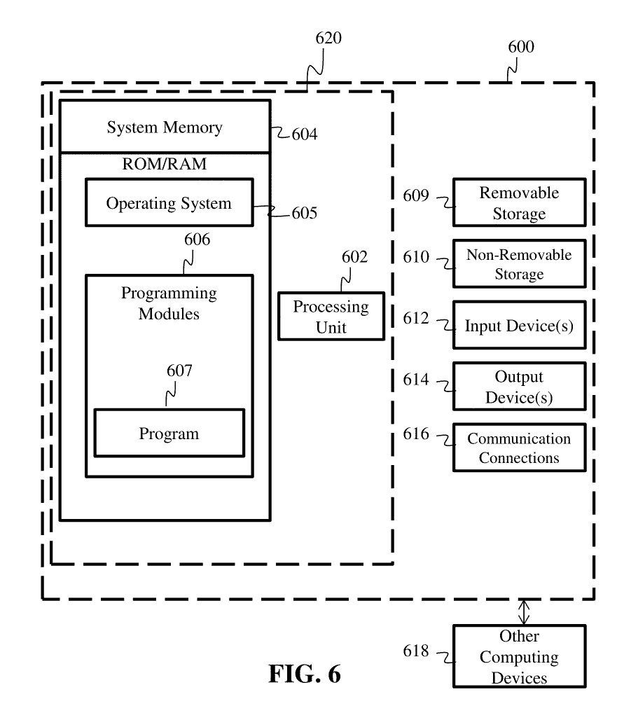

FIG. 1 is a block diagram of an operating environment 100 that supports the automatic accumulation of prepayment funds in a target account, according to an example embodiment. The environment 100 may comprise multiple point of sale (POS) terminals 120, multiple client computers 122 and a server 102 communicating via a communications network 106. Each of the computers 120, 122 and server 102 may be connected either wirelessly or in a wired or fiber optic form to the communications network 106. Computers 120, 122 and server 102 may each comprise a computing device 600, described below in greater detail with respect to FIG. 6. FIG. 1 shows that computers 120, 122 may comprise mobile computing devices such as cellular telephones, smart phones or tablet computers, or other computing devices such as a desktop computer, laptop, game console, dedicated POS terminal, for example. Communications network 102 may be a packet switched network, such as the Internet, or any local area network, wide area network, enterprise private network, cellular network, phone network, mobile communications network, or any combination of the above. FIG. 1 shows gas pump 123, toll booth 124 and vending machine 125 as alternatives to POS terminal 120, wherein the alternatives include a network connected computer having the same capabilities as POS terminal 120. Gas pump 123, toll booth 124 and vending machine 125 are all used to effectuate payments for gas, tolls or products via an electronic payment system.

Environment 100 may be used when multiple consumers or customers 110, 112 engage in consumer spending transactions and desire to accumulate funds using server 102. A consumer spending transaction comprises the purchase of a good or service using cash, a check, a credit card, a debit card, a gift card, store credit, or the like. Spending transaction data, or transaction data, comprises any of the data that is used or transferred during a consumer spending transaction, such as: the price paid for a good or service purchased, the individual price paid for any good or service purchased in a group of goods or services, any taxes paid and how the taxes were applied to each good or service purchased in a group, any prepayment or discounts that were provided to the consumer and how the prepayment were applied to each good or service purchased in a group, the date, the time, the location, the cashier's name, the account number that was used, the name of the consumer, any account data related to the account that was used to purchase the goods or services. The term spending amount refers to the price of one or more goods or services purchased (without or without applicable taxes, tariffs, discounts, setoffs, etc.), or the individual price of any good or service purchased in a group of goods or services.

An account is a record that logs transactions between a consumer and his account provider, the merchant, and the resulting position of the consumer with the account provider. An account may hold various pieces of information, the most significant being the current balance of prepaid funds, credits or money of the consumer. An account may refer to a prepaid account that holds funds, credits or money that the provider owes to the consumer.

Account data refers to information that identifies a particular account, such as an account number, the name of the account holder, a routing number, a SWIFT code, the name of the account provider, the address of the account provider, any numbers or codes printed on a physical card, any passwords, PIN numbers or other credentials associated with the account, etc.

Target account 180 is the prepayment account held by the merchant and offered by the merchant to the customers 110, 112 to which funds, credits or money are transferred in the methods 200 and 300 defined below. Each computer 120, 122 may connect directly to server 102, as defined in method 200.

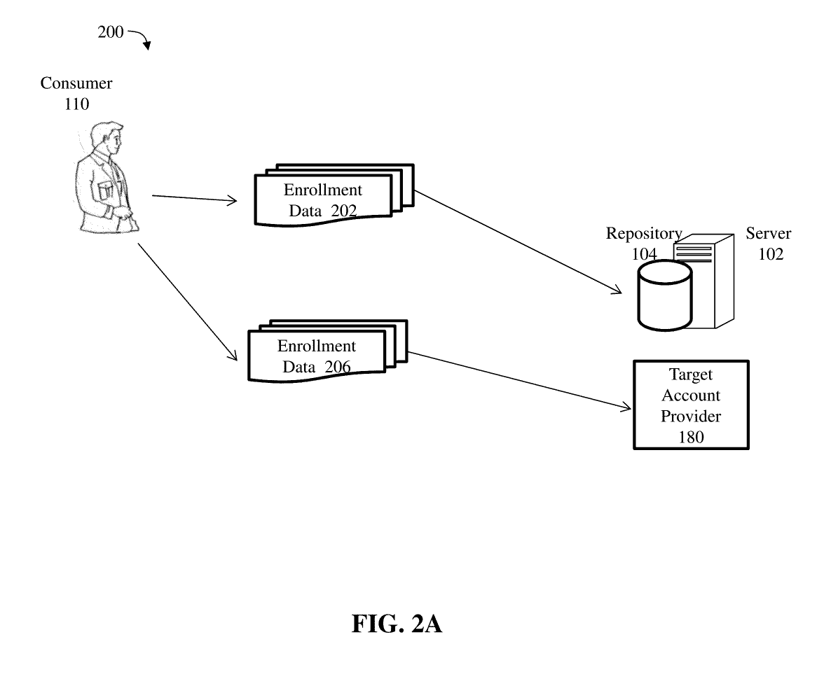

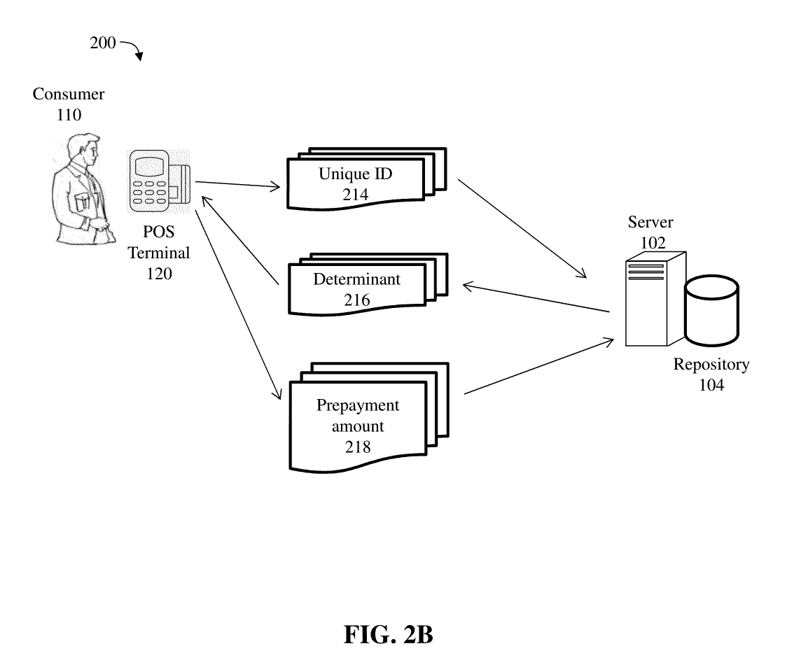

FIG. 1 further shows that server 102 includes a database or repository 104, which may be a relational database comprising a Structured Query Language (SQL) database stored in a SQL server. Computers 120, 122 may also each include their own database. The repository 104 serves data from a database, which is a repository for data used by server 102 and the client computers during the course of operation of the invention. The database 104 may include a consumer record for each consumer 110, 112. A consumer record may include: contact/identifying information for a consumer, spending transaction data of the consumer, a unique identifier for the consumer, demographic data for the consumer (such as age, sex, income data, race, color, marital status, etc.), source account(s) data, target account(s) data, any other account data, social security number, tax identification number, and prepaid scheme information, which is defined in created detail below with reference to FIG. 2A. A consumer record may also include a current monetary value, current value or balance of prepayment funds that represents an amount of funds, that has been saved using the disclosed embodiments and that is scheduled to be transferred to the target account.

FIG. 1 shows an embodiment wherein networked computing devices 120, 122 interact with server 102 and repository 104 over the network 106. Server 102 and POS terminal 120 include a software engine that delivers applications, data, program code and other information to each other and networked computing devices, such as 122. The software engine of server 102 or POS terminal 120 may perform other processes such as transferring multimedia data in a stream of packets that are interpreted and rendered by a software application as the packets arrive. It should be noted that although FIG. 1 shows only two networked computing devices 120, 122, and one server 102, the system of the supports any number of networked computing devices and servers connected via network 106.

Server 102 and POS terminal 120 include program logic comprising computer source code, scripting language code or interpreted language code that is compiled to produce executable file or computer instructions that perform various functions of the disclosed embodiments. In another embodiment, the program logic may be distributed among more than one of server 102, POS terminal 120, computer 122, or any combination of the above. In yet another embodiment, the program logic may comprise program module 607 in FIG. 6.

Note that although server 102 and POS terminal 120 are shown as single and independent entities, in one embodiment of, the functions of server 102 and POS terminal 120 may be integrated with another entity, such as one of the client computers or one or more of account providers 180. Further, server 102 and POS terminal 120 and their functionality, according to a preferred embodiment, can be realized in a centralized fashion in one computer system or in a distributed fashion wherein different elements are spread across several interconnected computer systems.

FIG. 2A is a diagram showing the data flow 200 of a setup process, according to an example embodiment. FIG. 2A depicts the transfer of data from an example consumer 110 to target account provider 180 and server 102. FIG. 2A shows that consumer 110 may provide enrollment data 206 to target account provider 180. The enrollment data 206 is used by the target account provider to establish a target account, such as a prepaid account, with the target account provider 180. Thus, enrollment data 206 may include any of the data that may be entered into a consumer record, as defined above. Note the system supports the creation of more than one target account with more than one target account providers.

FIG. 2A further shows that consumer 110 may provide enrollment data and change enrollment data 202 to server 102. The enrollment data 202 is used by the server 102 to establish or change a user account with server 102 and to define and store prepayment scheme information that defines how the consumer 110 intends to prepay for merchandise and services using the system. Thus, enrollment data 202 may include any of the data that may be entered into a consumer record, as defined above, as well as any of the enrollment data 206 Further, enrollment data 202 may include account data for one or more target accounts. In this document, the terms prepayment and prepaid are used interchangeably.

In one embodiment, with regard to enrollment data 202, the program logic of server 102 stores the account data, or a portion thereof, pertaining to one or more target accounts on a third party site via network 106.

As explained above, prepayment scheme information defines how the consumer 110 intends to prepay funds, credits or money using the system. Prepayment scheme information may include definitions for prepayment schemes. A first type of prepayment scheme involves rounding. Each time a consumer effectuates a consumer spending transaction, the spending amount is rounded up or increased by a small amount, referred to as a prepayment amount, up to a predefined amount. The prepayment amount, for example, may comprise an amount that rounds the spending amount up to the nearest selected whole dollar amount (i.e., $1.00, $2.00, $5.00, etc.), up to the nearest whole dollar amount plus an additional value, up to a percentage of the spending amount, up to a percentage of the spending amount plus an additional value, etc. In another example, the prepayment amount is simply an amount that is added to a spending amount. The prepayment amount is added to the current value in a consumer record of consumer 110, as defined in more detail below. The current value is the amount of funds, money or credit that is allocated for transferring to one or more target accounts.

The prepayment scheme may also include an extra dollars amount that defines a set amount of money that is added on top of another prepayment amount. For example, an extra dollar amount of $1.00, $2.00, $5.00, etc. may be added to a prepayment determinant that rounds the spending amount up to the nearest whole dollar amount. In this scheme, the program logic rounds the spending amount up to the nearest whole dollar amount and then adds the extra dollars amount to the resulting value.

Note that the enrollment of the target account with target account provider 180 and the enrollment of the user account with server 102 may be accomplished by the consumer 110 via his client computer, via voice interaction over a telephone, in person or by proxy.

A prepayment determinant is defined as any data that indicates which of the prepayment schemes defined above is used for a particular spending transaction. The prepayment determinant is stored in the consumer record associated with each consumer. In another embodiment, machine readable instructions may be used to define prepayment schemes as defined above. The machine readable instructions may be stored in the consumer record associated with each consumer. The machine readable instructions define an algorithm that, when executed, calculate a prepayment amount based on spending transaction data.

Note that the enrollment of the target account with target account provider 180, and the enrollment of the user account with server 102 may be accomplished by the consumer 110 via his client computer, via voice interaction over a telephone, in person or by proxy.

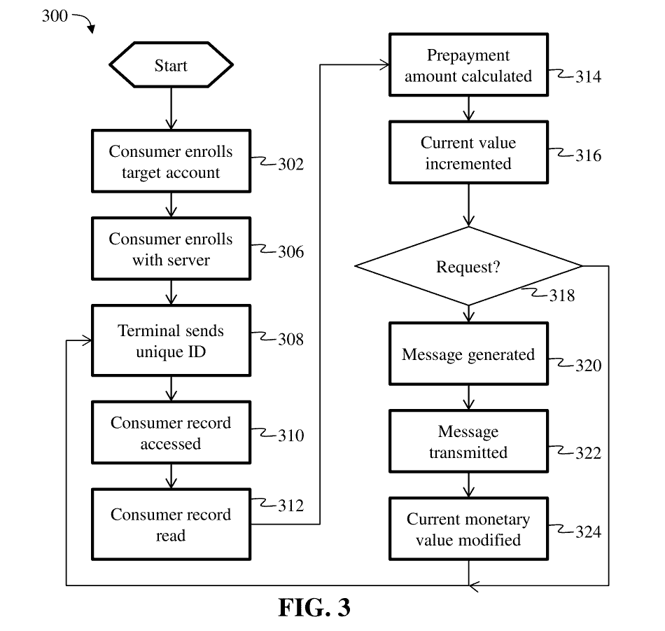

FIG. 2B is a diagram showing the data flow 200 of an automatic prepayment funds accumulation process, according to an example embodiment. FIG. 2B is described with reference to FIG. 3 below.

FIG. 3 is a flow chart of a method 300 for providing automatic accumulation of prepayment funds in a target account, according to an example embodiment. FIG. 3 depicts the actions of an example consumer 110, the terminal 120, and server 102 in the process of providing automatic accumulation of prepayment funds in a target account.

Method 300 may begin at stage 302 wherein the consumer 110 enrolls a target account with target account provider 180 by providing enrollment data 206, as defined in FIG. 2A above. Then, in stage 306 the consumer 110 enrolls a user account with server 102 by providing enrollment data 202, as defined in FIG. 2A above. In stage 308, the consumer 110 initiates a consumer spending transaction at POS terminal 120 (such as purchasing an item at a retail store) and subsequently sends unique identifier 214 to the server 102 via the network 106, as defined in FIG. 2B. In this step, the POS terminal 120 may read a spending amount corresponding to the product or serviced purchased at the terminal.

Next, in stage 310, the program logic of server 102 accesses the consumer record associated with the consumer 110. The program logic of server 102 may find the consumer record associated with the consumer 110 in database 104 using the unique identifier 214. Then, in stage 312, the program logic of server 102 reads the user record associated with the consumer 110. Particularly, the program logic of server 102 may read a prepayment determinant from the user record, and optionally an extra dollars amount. In another embodiment, the program logic of server 102 may also read machine readable instructions for calculating a prepayment amount from the user record. Further in step 312, the server 102 transmits the prepayment determinant 216 from the user record, and optionally an extra dollars amount, to the POS terminal 120 via network 106.

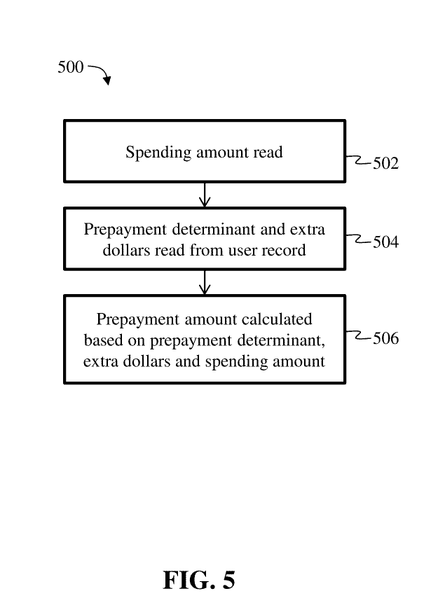

In stage 314, based on the data that was received in step 312, the POS terminal 120 calculates a prepayment amount based on the prepayment determinant (and optionally the extra dollars amount) and the spending amount (as defined in greater detail below with reference to FIG. 5). Alternatively, in step 314, the consumer may select a different prepayment determinant at the POS terminal. In this alternative, the POS terminal 120 calculates a prepayment amount based on the user-selected prepayment determinant (and optionally the extra dollars amount) and the spending amount. Also in this step 314, the POS terminal 120 transmits the prepayment amount 218 to the server 102 via network 106.

In step 316, the current monetary value in the consumer record of consumer 110 is incremented to include the prepayment amount. In step 318, the program logic of server 102 determines whether it has received a request from consumer 110, such as via network 106, to use his prepaid funds. If not, then control flows back to stage 308. If the request has been received, then in stage 320, the program logic of server 102 generates a message that includes a request to transfer the current value, or portion thereof to the target account. In step 324, the current value in the consumer record of consumer 110 is reduced by the amount that was transferred to reflect the transfer. In one embodiment, the current value in the consumer record of consumer 110 is reduced to zero to reflect the transfer of the entire current value to the target account.

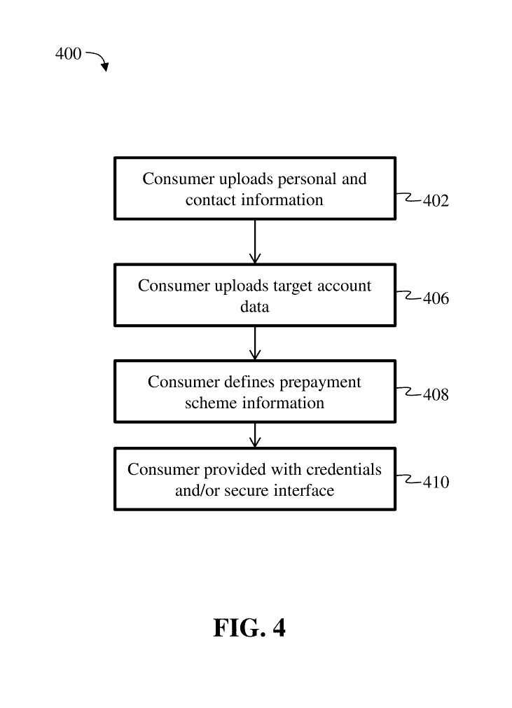

FIG. 4 is a flow chart of a method 400 for setting up the process of providing automatic accumulation of prepaid funds in a target account, according to an example embodiment. Method 400 depicts the process by which the consumer 110 sets up or initializes a user account with server 102. Method 400 starts with stage 402 wherein the user enters personal and contact information into server 102, such as any of the enrollment data 202 defined above. The data entered by the consumer 110 in stage 402 is stored in one or more consumer records associated with the consumer 110 in database 104. Next, in stages 404 and 406, the consumer 110 uploads source account data and target account data, respectively, into the database 104 of server 102, which data is stored in the consumer record(s) associated with the consumer 110. In stage 408, the consumer 110 uploads prepayment scheme information (as defined above) into the database 104 of server 102, which information is stored in the consumer record(s) of consumer 110.

Finally, in stage 410, the program logic of server 102 may provide the consumer 110 with secure credentials that allows the consumer to log securely into server 102 in the future. Alternatively, the program logic of server 102 may provide the consumer 110 with a secure interface that allows the consumer to interface securely with server 102 using, for example, an encrypted connection.

FIG. 5 is a flow chart of a method 500 for calculating a prepayment amount, according to an example embodiment. Note that method 500 provides greater detail about the processes 314 of FIG. 3. Method 500 may be implemented using a computing device 600 as described in more detail below with respect to FIG. 6. An example implementation of the stages of method 500 will be described in greater detail below.

In stage 502, the POS terminal 120 reads the spending amount of the consumer 110 of step 308 of method 300. By way of example, the spending amount may be given as $1.50. In stage 504, the POS terminal 120 receives the prepayment determinant and the extra dollars amount from server 102 over network 106, which the server read from the consumer record of consumer 110. In the given example, the prepayment determinant indicates rounding to the next whole dollar amount and the extra dollar amount is defined as $1.00. Finally, in step 506, the POS terminal 120 calculates the prepayment amount based on the prepayment determinant, the extra dollars amount and the spending amount. In the ongoing example, the spending amount of $1.50 is rounded to the nearest whole dollar amount of $2.00, and the extra dollars amount of $1.00 is added to the $2.00, such that the total amount charged to the consumer is $3.00 and such that the prepayment amount is calculated to be $1.50.

In an alternative embodiment, in stage 504, the POS terminal 120 receives from server 102 machine readable instructions from the consumer record of consumer 110. The machine readable instructions define an algorithm that, when executed, calculate a prepayment amount based on spending transaction data. In stage 506, the POS terminal 120 executes the machine readable instructions so as to calculate the prepayment amount based on the spending amount.

FIG. 6 is a block diagram of a system including an example computing device 600 and other computing devices. Consistent with the embodiments described herein, the aforementioned actions performed by terminal 120, by server 102 and the providers 170, 180 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for methods 300, 400 and 500 as described above. Methods 300, 400 and 500 may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of program logic. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of method 300's, method 400's or method 500's stages as described above. The aforementioned processes are examples, and processing unit 602 may perform other processes. Other programming modules that may be used in accordance with the embodiments may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for accumulating prepayment funds, comprising:
a database for storing a plurality of consumer profiles, wherein each profile includes a consumer unique identifier, a prepayment determinant, and a consumer account including a current monetary value;
a server communicably coupled with the database and with a communications network, the server configured for:
receiving from a point of sale (POS) terminal, via the communications network, a message including a consumer unique identifier;
accessing, in the database, a consumer profile that corresponds to the consumer unique identifier;
transmitting to the POS terminal, via the communications network, a message including a prepayment determinant from the consumer profile that corresponds to the consumer unique identifier;
receiving from the POS terminal, via the communications network, the message including a prepayment amount; and
incrementing the current monetary value in the consumer profile based on the prepayment amount; and
a POS terminal communicably coupled with the communications network, the POS terminal configured for:
reading input from a consumer, wherein the input includes a consumer unique identifier;
transmitting to the server, via the communications network, a message including the consumer unique identifier;
receiving from the server, via the communications network, a message including a prepayment determinant from the consumer profile that corresponds to the consumer unique identifier;
reading a spending amount;
calculating a prepayment amount based on the prepayment determinant and the spending amount; and
transmitting to the server, via the communications network, a message including the prepayment amount.

2. The system of claim 1, wherein the prepayment determinant further comprises machine readable instructions for calculating a prepayment amount.

3. The system of claim 2, wherein the step of calculating a prepayment amount further comprises executing the machine readable instructions for calculating the prepayment amount based on the prepayment determinant and the spending amount.

4. The system of claim 3, wherein a consumer profile further defines a target account, which comprises a merchant account.

5. The system of claim 4, wherein the target account comprises two or more separate accounts.

6. The system of claim 5, the server further configured for:
transmitting, over the communications network, a request to transfer a portion of the current monetary value to the target account defined in the consumer profile; and
reducing the current monetary value by the portion transferred to the target account.

7. A system for accumulating prepayment funds, comprising:
a database for storing a plurality of consumer profiles, wherein each profile includes a consumer unique identifier, a prepayment determinant, an extra dollar amount, and a consumer account including a current monetary value;
a server communicably coupled with the database and with a communications network, the server configured for:
receiving from a point of sale (POS) terminal, via the communications network, a message including a consumer unique identifier;
accessing, in the database, a consumer profile that corresponds to the consumer unique identifier;
transmitting to the POS terminal, via the communications network, a message including a prepayment determinant and an extra dollar amount from the consumer profile that corresponds to the consumer unique identifier;
receiving from the POS terminal, via the communications network, the message including a prepayment amount and the extra dollar amount; and
incrementing the current monetary value in the consumer profile based on the prepayment amount and the extra dollar amount; and
a POS terminal communicably coupled with the communications network, the POS terminal configured for:
reading input from a consumer, wherein the input includes a consumer unique identifier;
transmitting to the server, via the communications network, a message including the consumer unique identifier;
receiving from the server, via the communications network, a message including a prepayment determinant and an extra dollar mount from the consumer profile that corresponds to the consumer unique identifier;
reading a spending amount;
calculating a prepayment amount based on the prepayment determinant, the extra dollar amount and the spending amount; and
transmitting to the server, via the communications network, a message including the prepayment amount.

8. The system of claim 7, wherein the prepayment determinant further comprises machine readable instructions for calculating a prepayment amount.

9. The system of claim 8, wherein the step of calculating a prepayment amount further comprises executing the machine readable instructions for calculating the prepayment amount based on the prepayment determinant, the extra dollar amount and the spending amount.

10. The system of claim 9, wherein a consumer profile further defines a target account, which is a merchant account.

11. The system of claim 10, wherein the target account comprises two or more separate accounts.

12. The system of claim 11, the server further configured for:
transmitting, over the communications network, a request to transfer a portion of the current monetary value to the target account defined in the consumer profile; and
reducing the current monetary value by the portion transferred to the target account.

13. A computer system, connected to a communications network, for accumulating funds, the system comprising:
a database for storing a plurality of consumer profiles, wherein each profile includes a consumer unique identifier, a prepayment determinant, and a consumer account including a current monetary value;
a server communicably coupled with the database, the server comprising a memory storage, a network connection device communicably coupled with the communications network, and a processing unit coupled to the memory storage, and the network connection device, wherein the processing unit is operative for:
receiving from a point of sale (POS) terminal, via the communications network, a message including a consumer unique identifier;
accessing, in the database, a consumer profile that corresponds to the consumer unique identifier;
transmitting to the POS terminal, via the communications network, a message including a prepayment determinant from the consumer profile that corresponds to the consumer unique identifier;
receiving from the POS terminal, via the communications network, the message including a prepayment amount; and
incrementing the current monetary value in the consumer profile based on the prepayment amount; and
a POS terminal comprising a memory storage, a network connection device communicably coupled with the communications network, and a processing unit coupled to the memory storage, and the network connection device, wherein the processing unit is operative for:
reading input from a consumer, wherein the input includes a consumer unique identifier;
transmitting to the server, via the communications network, a message including the consumer unique identifier;
receiving from the server, via the communications network, a message including a prepayment determinant from the consumer profile that corresponds to the consumer unique identifier;
reading a spending amount;
calculating a prepayment amount based on the prepayment determinant and the spending amount; and
transmitting to the server, via the communications network, a message including the prepayment amount.

14. The computer system of claim 13, wherein the prepayment determinant further comprises machine readable instructions for calculating a prepayment amount.

15. The computer system of claim 14, wherein the step of calculating a prepayment amount further comprises executing the machine readable instructions for calculating the prepayment amount based on the prepayment determinant and the spending amount.

16. The computer system of claim 15, wherein a consumer profile further defines a target account, which comprises a merchant account.

17. The computer system of claim 16, wherein the target account comprises two or more separate accounts.

18. The computer system of claim 17, the server further configured for:
transmitting, over the communications network, a request to transfer a portion of the current monetary value to the target account defined in the consumer profile; and
reducing the current monetary value by the portion transferred to the target account.
